(19) United States
(12) Patent Application Publication
(10) Pub. No.: US 2007/0107040 A1
(43) Pub. Date: May 10, 2007

(54) Secure information ID software/program

(76) Inventor: Robertino Catalin Cazacu, Montgomery Village, MD (US)

Correspondence Address: ROBERTINO CAZACU, P.O. BOX 87111, MONTGOMERY VILLAGE, MD, 20886, US

(21) Appl. No.: 11/267,853

(22) Filed: Nov. 7, 2005

(51) Int. Cl. H04L 9/00

(52) U.S. Cl. 726/1

(57) ABSTRACT

A program that stores personal, family and general information on a CD Rom, Diskette, Flash, Jump, Hard drive, etc. The program contains several tabs entitled Personal, Medical, Credit Card, Passport, Insurance, Pet, Parents, School, Users, Phone Book, My Files and Other, and corresponding fields. For example Users Information allows several users to input information found on a driver license, fingerprint, picture, numbers, social security number, and more. My Files stores any data that is downloaded into the software. The auto fill automatically fills any form or log in screen for you on line. All or part of the information can be saved in a password protected mode or a public mode. The public mode allows anyone like the Paramedics or Police to quickly identify and learn about your medical history. In the event a child is kidnapped, the proper authorities can quickly extract pictures, fingerprints and additional information as needed.

### BACKROUND OF THE INVENTION

The present invention relates to a program that can be stored on your computer or on a flash drive, jump drive, small business card CD Rom that will allow the later to be carried safely in your pocket by means of password protection. Unlike any other product you can carry a wealth of information such as but not limited to; information related to oneself, other acquaintances or any information pertaining to your daily routines. Included in the software will be a an Emergency Guide which is a section of the software that is dedicated to “what do” in case of natural or biological attack. In addition to its other one of kind features already mentioned the program would also have the ability to fill in automatically any form while on the Internet.

### SUMMARY OF THE INVENTION

It is an object of the present invention to provide a program for facilitating a way of carrying your personal information on a CD Rom or any other product that stores information, especially when recognizing that no program can store such a vast amount of information whether personnel or general in nature and allow you to edit the fields for optimal organization and than choose which part of that information you want to password protect and which you want to leave open for public access. In most cases the information stored in the public folder is in case of an emergency where a doctor might need access to numbers and medical history, where one does not wish to carry a personal agenda, all state issued ID's or any other instance in which one desires to minimize the amount of information carried by storing it all on the Secure Information ID, also known as a business card CD Rom. Furthermore that information can be accessed via any computer by simply inserting the SIID (Secure Information ID) card in the CD Rom tray of any computer and later if one choose to, to allow the program to automatically fill any forms, applications or the like encountered while accessing the internet.

### BRIEF DESCRIPTION OF THE DRAWINGS

This disclosure will present in detail the following description of preferred embodiment with reference to the following figures wherein:

FIG. 1

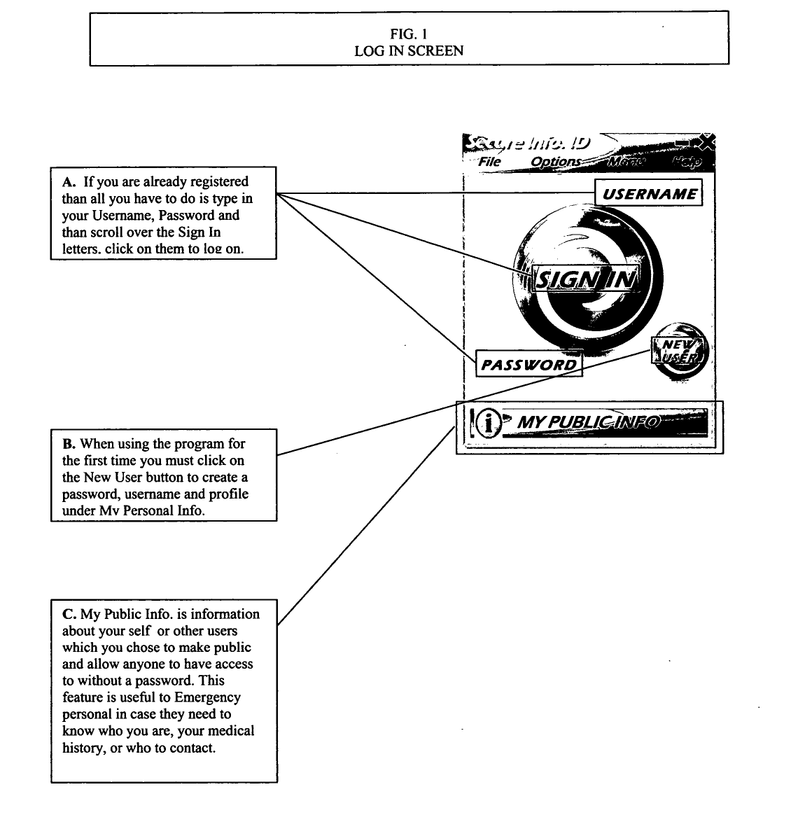

Log in Screen.

A. Requires an already registered user to type in their username, password and to click on the Sign In button to log in.
B. Click on the New User button in order to create a username, password, and to start inputting personal information. There is no limit as to how many users information the program can hold, it is only limited by the capacity of that particular object that stores the program.
C. My Public Information button is a way to have direct access to any information that you saved in a none secure (no password) format.

FIG.2

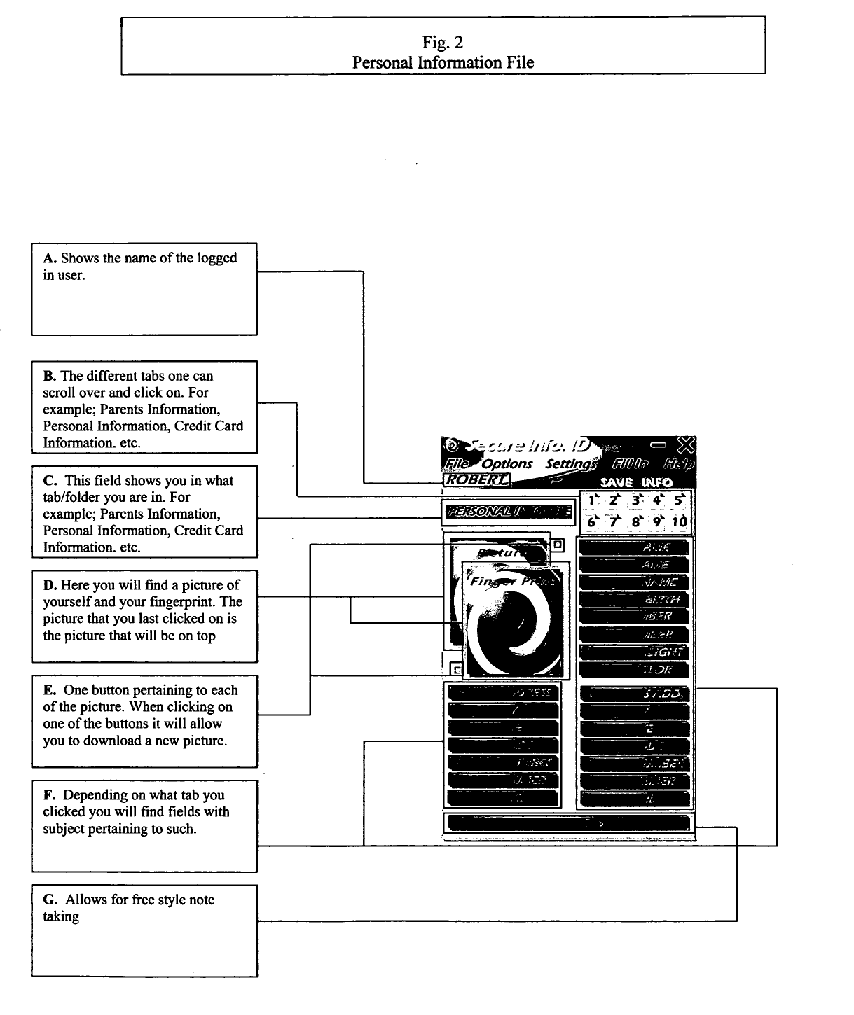

Personal Information Screen.

A. Shows the name of the logged in user.
B. The different tabs you can click on to access the different files such as Personal Information, Parents Information, Pet Information, Phone Book, etc.
C. Field showing the title of the file that your are currently working in.
D. Two frames will hold one picture of yourself and another of your fingerprint.
E. Buttons that will allow you to input or change the picture and/or fingerprint.
F. Totally customizable fields with titles pertaining to the name of the tab.
G. Field that allows you to take extensive notes.

FIG. 3

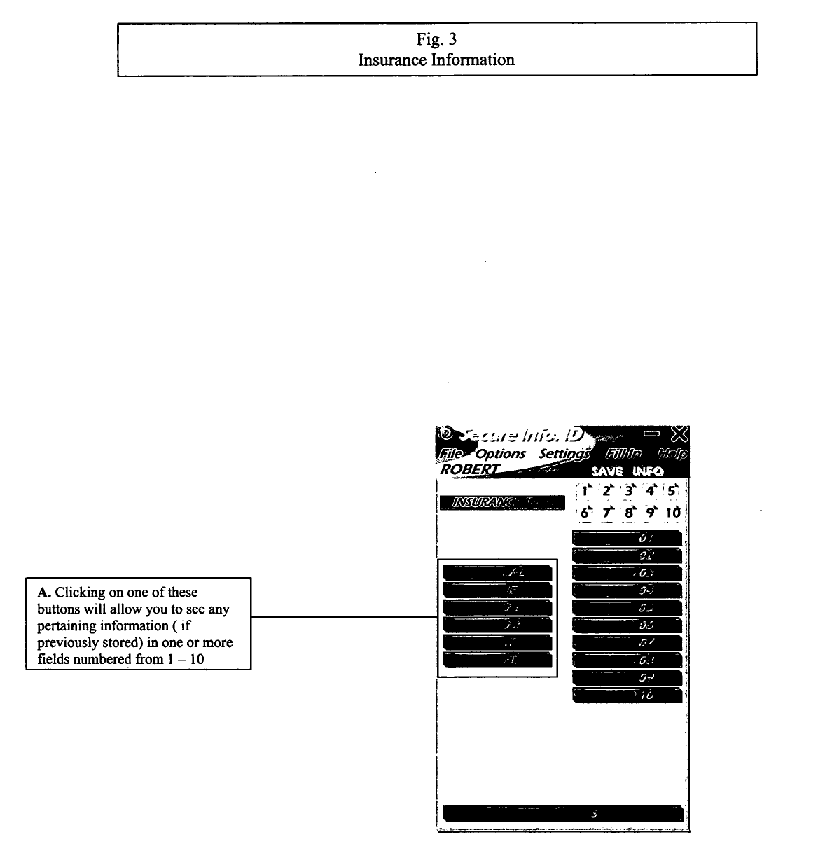

Insurance Information Screen.

A. By clicking on one of the buttons titled; Medical, Home, Auto, etc. one can see the information pertaining to that tab in the fields numbered from one to ten (Field 1, Field 2, etc.)

FIG. 4

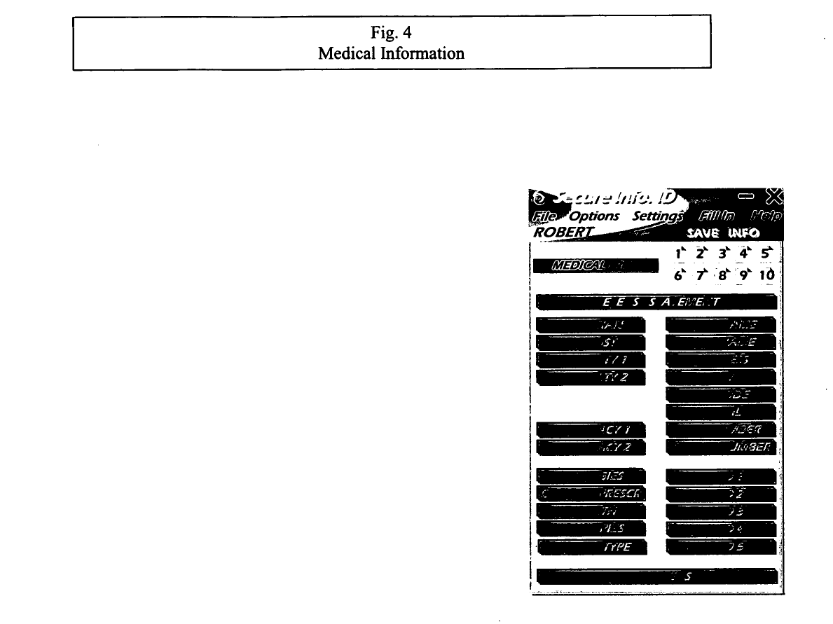

Medical Information Screen.

Click on one of the buttons in the left hand column to see the fields with pertaining information in the right hand column.

FIG. 5

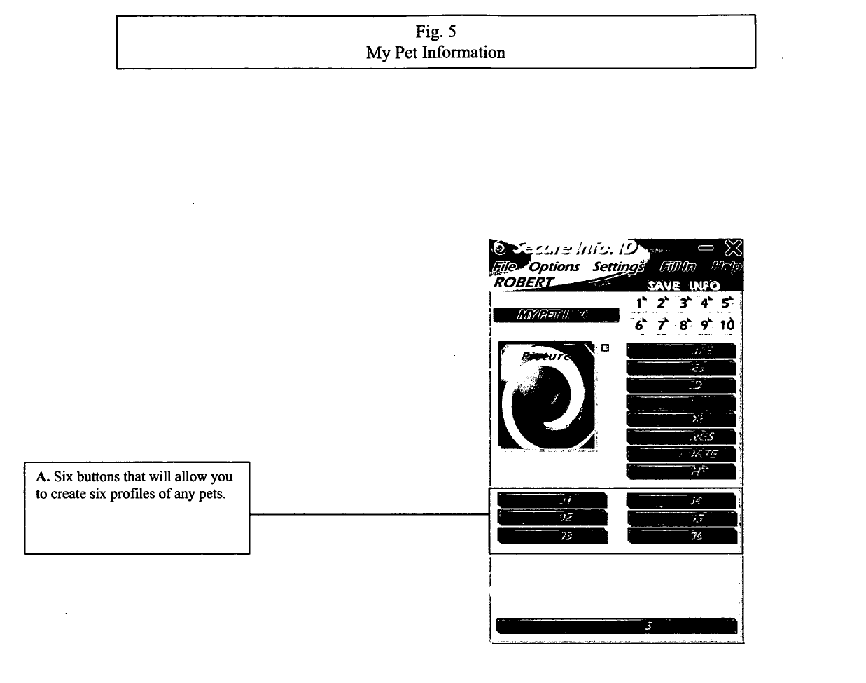

My Pet Information Screen.

A. There are six buttons which is the maximum animal profiles you can input. Pertaining information can be seen in the rest of the fields in the right hand column.

FIG. 6

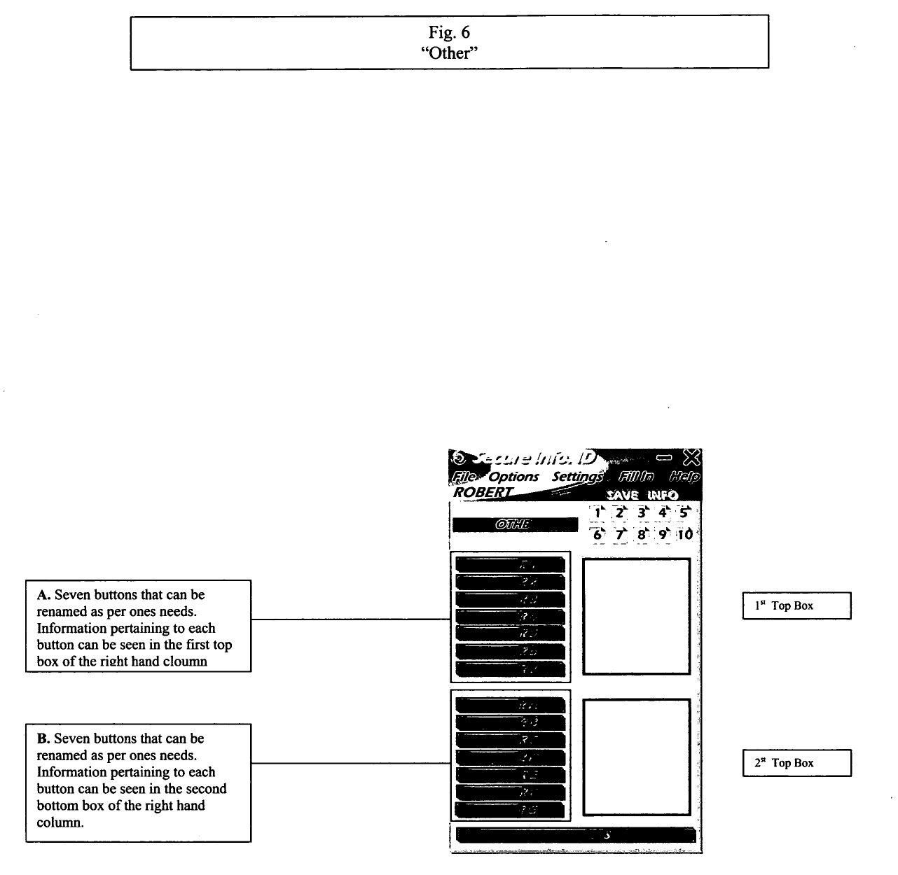

“Other” Information Screen.

A. The first set of seven buttons (Other 1-7) can be renamed as per your need. Once you rename and click on one of the buttons you will see pertaining information typed in the small window (1^{st} top right hand side column).
B. The second set of seven buttons (Other A-G) can be renamed as per your need. Once you rename and click on one of the buttons you will see pertaining information typed in the small window (2^{nd} bottom right hand side column).

FIG. 7

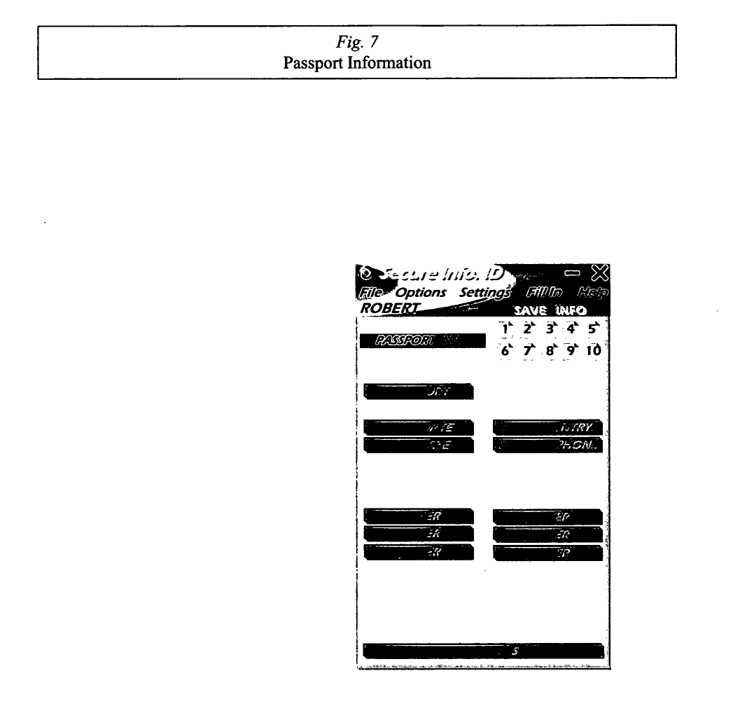

Passport Information Screen.

Self explanatory.

FIG.8

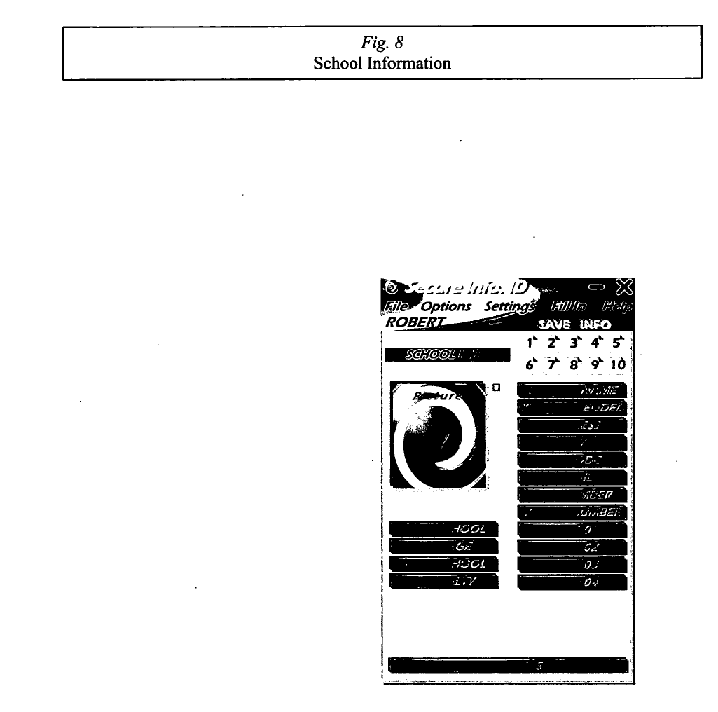

School Information Screen.

Similar layout, buttons on the left, fields on the right. One can differentiate buttons from fields by the pop window that pops up when scrolling over the field/button indicating its property.

FIG. 9

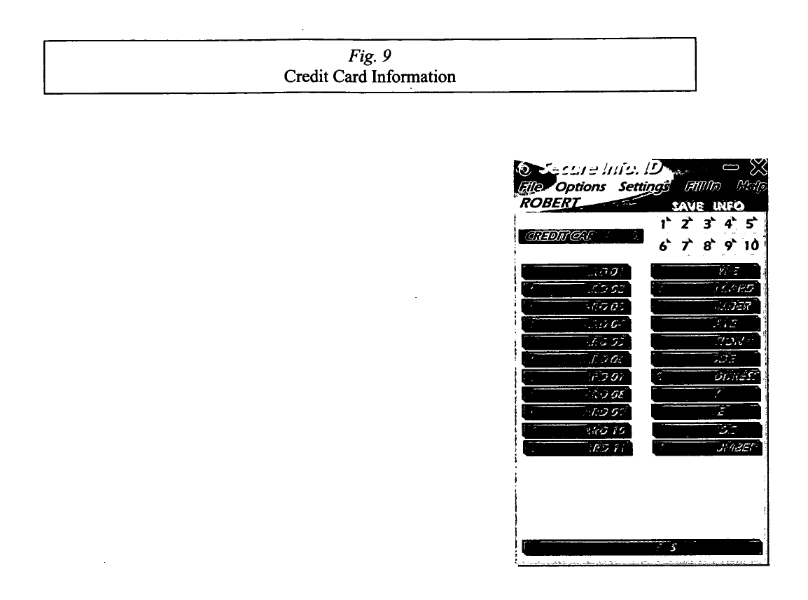

Credit Card Information Screen.

You will find eleven buttons on the left hand side, fields on the right hand side pertaning to the buttons.

FIG. 10

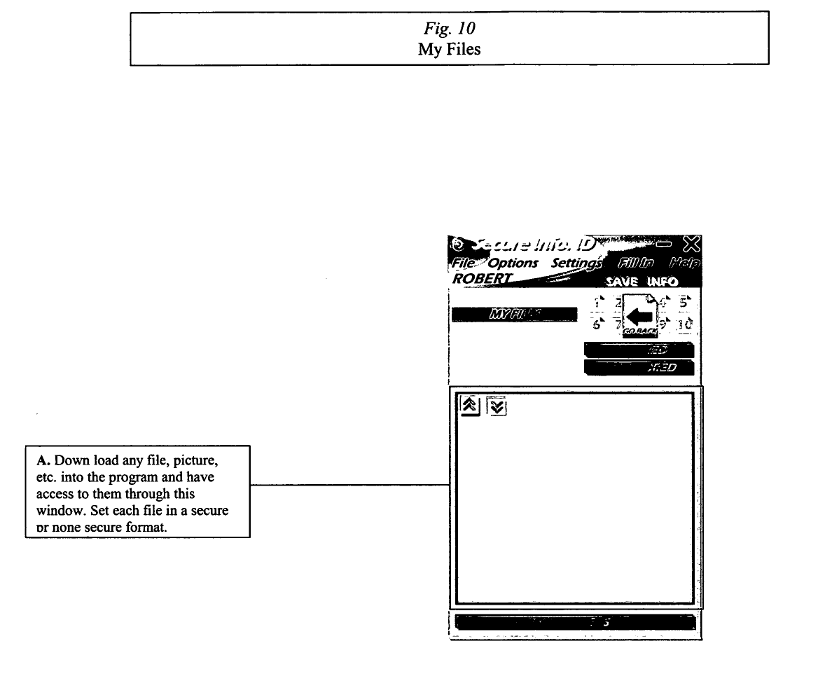

My Files Screen.

This option is accessible through the main menu by clicking on File and selecting My Files.
A. By clicking on the right hand button of the mouse inside the window you will have the option to import, delete, new, open, extract, or change any file, picture, etc.

FIG. 11

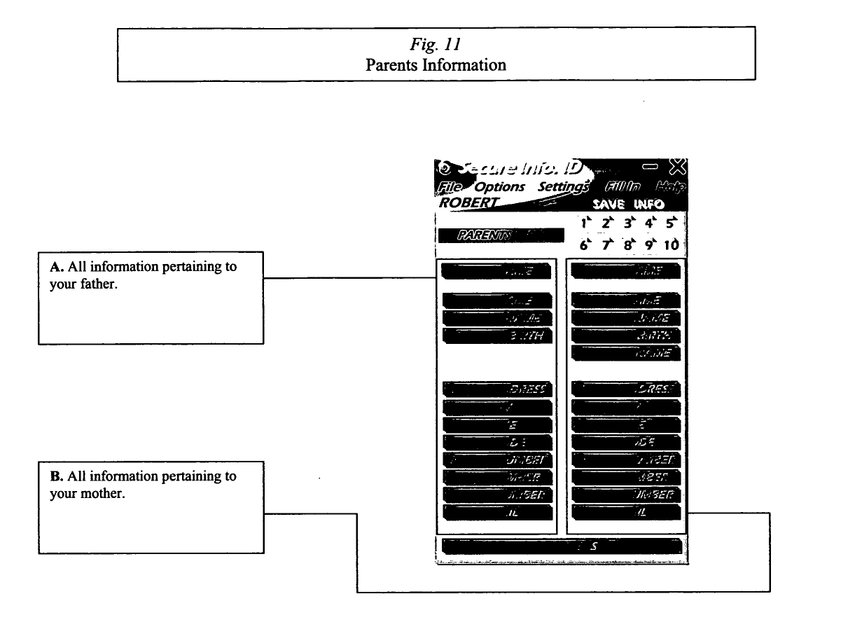

Parents Information Screen.

A. Input all information that pertains to your father.
B. Input all information that pertains to your mother.

FIG. 12

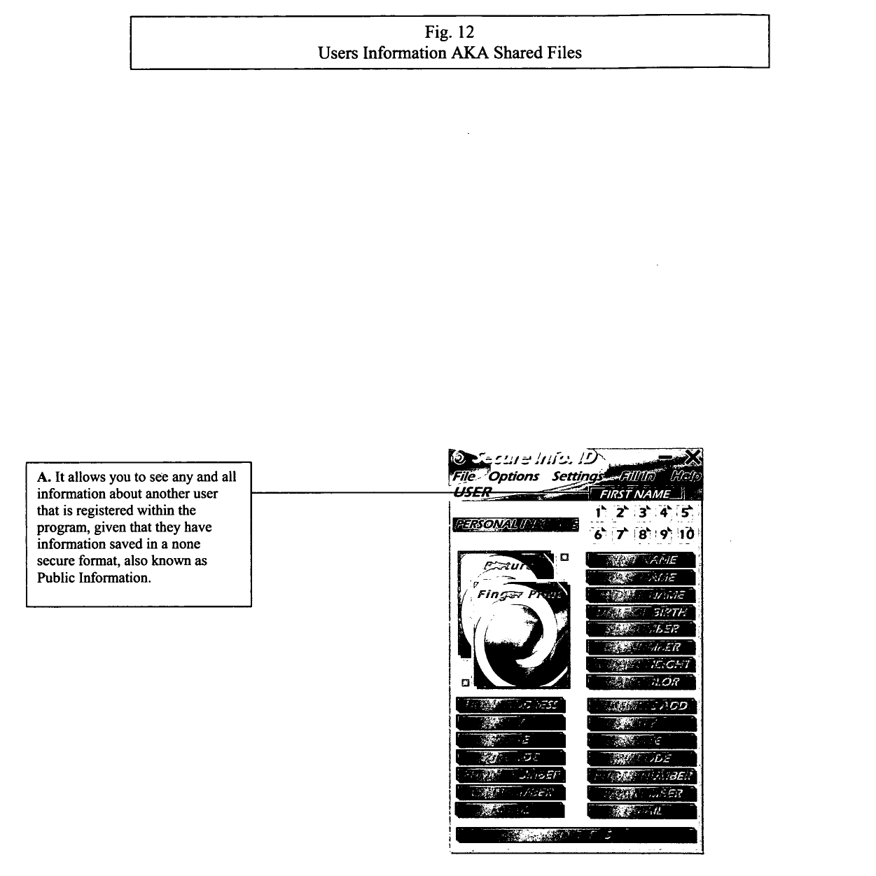

My Public Information, AKA Shared Files Screen.

This option is accessible through the main menu by clicking on File and selecting Shared Files.
A. Shows you the name of any of the other users who shares the program that has any information pertaining to them saved in a none secure format, also known as My Public Information.

FIG. 13

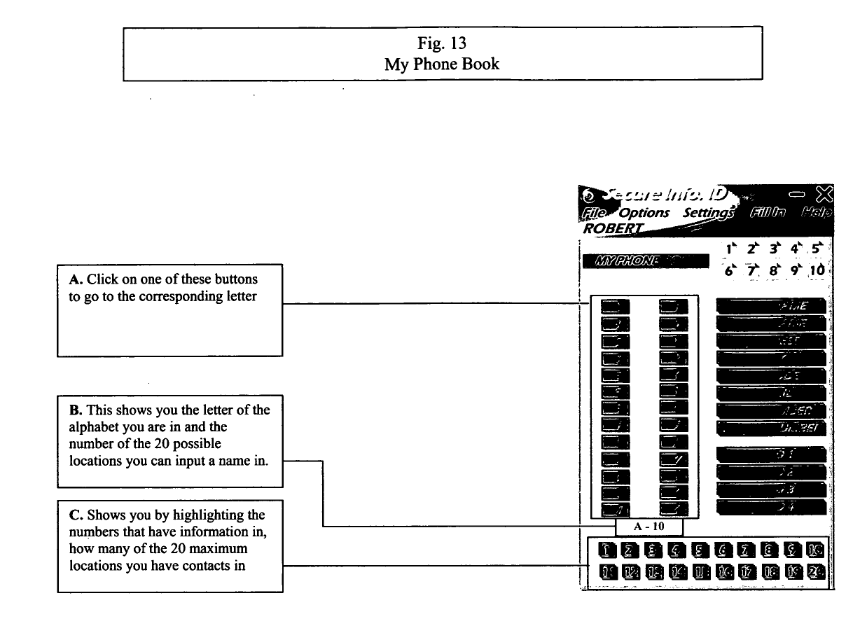

My Phone Book Screen.

A. Every letter of the alphabet has a designated button, by clicking on a particular button you will find yourself looking at information inputted in relation to that alphabet letter.
B. The first letter shows you the letter that you clicked on and the number shows you which of the maximum twenty contacts you are in.
C. Your agenda can hold a maximum of twenty unique contacts in any given letter of the alphabet. Only the numbers that contain information will change in color from a regular black to a red. Thus allowing you to see which of the twenty spaces are filled.

### DETAILED DESCRIPTION OF THE INVENTION

A CD Rom of any size shape or form preprogrammed with the software and/or part of an actual Credit Card issued by a particular bank. The later would place a CD Rom on the back of a bank issued credit card. Unless one wishes to install the program directly on their C: drive than the program stored on the CD Rom which described in the first sentence of the paragraph entitled Detailed Description Of The Invention could be accessible through the CD Rom of any computer and allow you to do the following; The software contains an agenda with tabs numbered and entitled: First tab entitled Personal Information with fields entitled home and work address, phone numbers, name, date of birth, social security number, driver license number, weight, hair color, an actual picture of oneself, finger print, a note section and additional fields entitled other. When using the word “other” one can automatically assume that these fields are fully editable to whatever name one wants. The same goes for the already preset fields already mentioned and those that will be mentioned in the paragraphs to come. Second tab entitled Medical Information. Numbering of the tabs is in no particular order when counting that before mentioned or those that we will be explaining of to come. Medical Information contains fields entitled physicians and pharmacies address and phone numbers, allergies, current prescription, health, surgeries, blood type, notes, ones personal information, other and a release form. Third tab entitled Credit Card Information contains fields entitled card type, name on card, card number, expiration date, verification number, pin code, billing address, phone numbers, notes and additional fields entitled credit card #1, credit card #2 all the way to credit card #11. Fourth tab entitled My Phone Book containing fields entitled name, address, phone numbers, email address and other. Along side these fields you will find a designated button for each letter of the alphabet. At the bottom of the screen you will find a designated button for each of twenty numbers, their purpose to be explained. The phone book works as thus; click on one of the alphabet letters, depending on how many persons previously inputted in the phone book under that letter the corresponding number will light up, therefore showing you how many contacts you have under that particular alphabet letter. Fifth tab entitled Passport Information containing fields entitled issuing country, issuing date, expiration date, embassy phone number and address, other and notes. Sixth tab entitled Users Information contains the same fields as Personal Information, yet serves another purpose as thus; Users Information allows multiple users whether family, friends or others to use the same program and make that information in part or in whole public to allow anyone and everyone to have access to their profile, again in most cases do to an emergency. It is important to realize that even though there might be several users on one program, you will only see their open access information and will not have access to their password protected files unless they provide you with the password. Seventh tab entitled Insurance Information containing fields entitled medical, home, auto #1, auto #2, boat and other and notes. Opposite to these fields you will find ten empty fields entitled other for specific customization. Eighth tab is entitled My Files containing no fields, instead an empty space that will allow you to download, import, export, etc. documents, files, programs or the like and save them on your SIID card in a secure or none secure format. This tab will also allow the user to have access to any open access files, programs, documents, etc. saved, which is the same as downloading, importing, etc. by any user using the same program. Ninth tab entitled Other contains two sets of seven fields entitled other and a small window, one for each of the seven fields to allow the user two type in any information pertaining to the name given to one of the fields originally entitled other. Notes will also be found in the tab entitled Other. Tenth tab entitled My Pet Information contains fields entitled pet name, specie, breed, sex color, markings, birth date, weight, notes and fields for inputting six more pets information along with a picture of each. Eleventh tab is entitled Parents Information containing fields entitled father and mothers name, date of birth work and home address, telephone numbers, email and notes. Twelfth tab entitled School Information contains fields entitled school name, years attended, address, phone numbers, other and notes. Along side you will find buttons entitled junior high, high school, college, university, specialty, etc. Once you click on one of these buttons pertaining information will appear, such as school name, years attended, and so on. Therefore the fields under the different tabs are setup as an agenda that allows the user to add, delete or edit not only the information inputted but also the fields themselves to allow for better organization. In turn this information is recognized by the program and uses it to automatically fill in any forms while on line, thus saving the user time and the effort of typing over and over again the same information. If one desires to limit the information to be filled than the drag and drop method is a second alternative. The drag and drop method allows you to click on a field in the program and drag it into the corresponding field of a form in another window. Accessible through the menu by selecting “SIID skins” one can choose from over 12 different colors, layout and different functionalities for their program. In addition to the principal functionality of the program included you will find a folder entitled Emergency Guide. The Emergency Guide is composed of several documents listed in alphabetical order in regards to the ways, methods and actions one would take in the event of a natural disaster or biological attack. Thus concluding the concept.

What is claimed is:

1. A program that allows you to store not only all of your personal information but general information under tabs entitled; Personal Information, Medical Information, Credit Card Information, Phone Book, Passport Information, Users Information, Insurance Information, My Files, Pet Information, Parents Information, School Information and Other.

2. All tabs and corresponding fields are fully editable to the extent that you can rename, resize, move or delete in part or the whole of their attributes.

3. The program and its content can be stored on a CD Rom of any size, shape or color, Flash Drive, Hard Drive or any other product that allows you to do the same.

4. The user has the option to save the information stored on the CD Rom, Flash Drive, Hard Drive or any other product that allows you to do the same in part or in whole using the password protect feature.

5. The tab entitled Users Information allows you to access the personal information of another user, since the program allows multiple users, yet limited to only that information which was saved as public information and nothing that would be saved using the pass word protect option.

6. Another tab entitled My Files allows any user to download any type of file, document, etc. into the program and save it in a secure format using the pass word option or save it as an open file, document, etc. The later would allow any one to have access to such documents due to the fact that it is saved under the open file option.

7. All information saved on the program can be used to allow the user by the click of a button to automatically fill any computer form, application, log in screen, or the like, instantly.

8. If a similar result is desired as described in #6 but limiting the final result to the extent that one desires to only fill in particular fields and not the entire form, application, log in screen, etc. then the drag and drop mode will do just that. Right clicking on a field that contains inputted information, by holding the button down and dragging the information from that field to another field in another window will initiate such a transfer.

9. As a companion tool the Emergency Guide is a file comprised of fifty pages plus of what to do and the possible consequences if a Natural Disaster or Biological attack was to take place.
